(19) United States
(12) Patent Application Publication
(10) Pub. No.: US 2002/0036234 A1
(43) Pub. Date: Mar. 28, 2002

(54) Spectral data collector which includes a lambertian reflector

(76) Inventors: Hong Tang, Suwanee, GA (US); Yeming Gu, Suwanee, GA (US)

Correspondence Address: PAUL W. MARTIN, LAW DEPARTMENT, WHQ-5E, 1700 S. PATTERSON BLVD., DAYTON, OH, 45479-0001, US

(21) Appl. No.: 10/002,735

(22) Filed: Nov. 15, 2001

Related U.S. Application Data
(62) Division of application No. 09/539,544, filed on Mar. 31, 2000.

(51) Int. Cl. G06K 7/10; G06K 7/14

(52) U.S. Cl. 235/454

(57) ABSTRACT

A produce data collector which operates with less than uniform lighting. The produce data collector includes a light source for illuminating a produce item with light, collecting optics for collecting reflected light from the produce item including a Lambertian reflector, a light separating element which produces an image from collected light, and an image capture device which captures discrete wavelengths within the collected light.

### CROSS-REFERENCE TO RELATED APPLICATIONS

The present invention is related to the following commonly assigned and co-pending U.S. application:

“A Produce Data Collector And A Produce Recognition System”, filed Nov. 10, 1998, invented by Gu, and having a Ser. No. 09/189,783.

### BACKGROUND OF THE INVENTION

The present invention relates to product checkout devices and more specifically to a produce data collector which includes a Lambertian reflector.

Bar code readers are well known for their usefulness in retail checkout and inventory control. Bar code readers are capable of identifying and recording most items during a typical transaction since most items are labeled with bar codes.

Items which are typically not identified and recorded by a bar code reader are produce items, since produce items are typically not labeled with bar codes. Bar code readers may include a scale for weighing produce items to assist in determining the price of such items. But identification of produce items is still a task for the checkout operator, who must identify a produce item and then manually enter an item identification code. Operator identification methods are slow and inefficient because they typically involve a visual comparison of a produce item with pictures of produce items, or a lookup of text in table. Operator identification methods are also prone to error, on the order of fifteen percent.

A produce data collector disclosed in the co-pending application includes a spectrometer. The spectrometer preferably includes a linear variable filter (LVF) and a linear diode array (LDA), which capture spectral information about a produce item.

The spectrometer works best when substantially uniform illumination is present. However, substantially uniform illumination may be more costly to provide. Therefore, it would be desirable to provide a produce data collector which will work with less than substantially uniform illumination.

### SUMMARY OF THE INVENTION

In accordance with the teachings of the present invention, a produce data collector which includes a Lambertian reflector is provided.

The produce data collector includes a light source for illuminating a produce item with light, collecting optics for collecting reflected light from the produce item including a Lambertian reflector, a light separating element which produces an image from collected light, and an image capture device which captures discrete wavelengths within the collected light.

In a preferred embodiment, the collecting optics includes a compound parabolic mirror having a focal region, wherein the Lambertian reflector is substantially located in the focal region, and a collimating lens which collimates scattered light from the Lambertian reflector.

It is accordingly an object of the present invention to provide a produce data collector which includes a Lambertian reflector.

It is another object of the present invention to provide a produce data collector which has a high collection efficiency.

It is another object of the present invention to provide a produce data collector which works with less than uniform lighting.

It is another object of the present invention to provide a produce data collector in which the amount of reflected light from the produce item which is incident on a detector within the produce data collector is maximized.

It is another object of the present invention to provide a produce data collector which uses a Lambertian reflector to uniformly distribute reflected light from any illuminated area on the surface of a produce item over a detector within the produce data collector.

It is another object of the present invention to provide a produce data collector which uses a Lambertian reflector and a compound parabolic collector to uniformly distribute reflected light from any illuminated area on the surface of a produce item over a detector within the produce data collector.

It is another object of the present invention to provide a produce data collector which uses a combination of a Lambertian reflector and a collimating lens to minimize incident angles of reflected light on a LVF-type light separating element.

### BRIEF DESCRIPTION OF THE DRAWINGS

Additional benefits and advantages of the present invention will become apparent to those skilled in the art to which this invention relates from the subsequent description of the preferred embodiments and the appended claims, taken in conjunction with the accompanying drawings, in which:

FIG. 1 is a block diagram of a produce recognition system, including the produce data collector of the present invention;

FIG. 2 is a diagrammatic view of a first embodiment of the produce data collector of the present invention;

FIG. 3 is a diagrammatic view of a second embodiment of the produce data collector of the present invention; and

FIG. 4 is a perspective diagrammatic view of a first modification to the second embodiment; and

FIG. 5 is a diagrammatic view of a second modification to the second embodiment.

### DETAILED DESCRIPTION OF THE PREFERRED EMBODIMENT

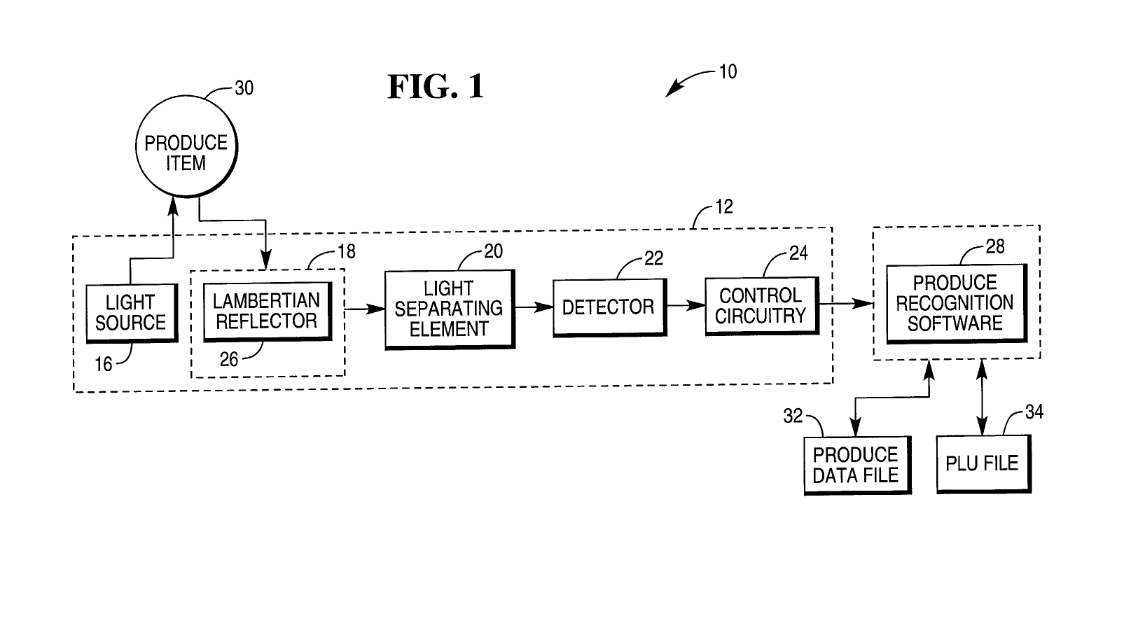

Referring now to FIG. 1, produce recognition system 10 includes produce data collector 12 and computer 14.

Produce data collector 12 collects data from produce item 30. Produce data collector 12 includes light source 16, light collecting optics 18, light separating element 20, detector 22, and control circuitry 42.

Light source 16 illuminates produce item 30. Light source 16 preferably produces a white light spectral distribution, and preferably has a range from four hundred 400 nm to 700 nm, which corresponds to the visible wavelength region of light.

Light source 16 preferably includes one or more light emitting diodes (LEDs) arranged in a ring. A broad-spectrum white light producing LED, such as the one manufactured by Nichia Chemical Industries, Ltd., is preferably employed because of its long life, low power consumption, fast turn-on time, low operating temperature, good directivity. Alternate embodiments include additional LEDs having different colors in narrower wavelength ranges and which are preferably used in combination with the broad-spectrum white light LED to even out variations in the spectral distribution and supplement the spectrum of the broad-spectrum white light LED. This arrangement illuminates produce item 30 uniformly and efficiently. The intensity of the LEDs causes an acceptable mount of reflected light to reach detector 22.

Other types of light sources 40 are also envisioned by the present invention, although they may be less advantageous than the broad spectrum white LED. For example, a tungsten-halogen light may be used because of its broad spectrum, but produces more heat.

A plurality of different-colored LEDs having different non-overlapping wavelength ranges may be employed, but may provide less than desirable collector performance if gaps exist in the overall spectral distribution.

Light collecting optics 18 collects light reflected from produce item 30. Light collecting optics 18 preferably includes Lambertian reflector 26, which increases the amount of reflected light and uniformly distributes them onto detector array 22. Light collecting optics 18 also may include additional optical elements for directing and focusing light from produce item 30.

Light separating element 20 and detector 22 together form a spectrometer which captures color and other information from light collected from produce item 30.

Light separating element 20 splits light into a continuous band of wavelengths of light. Light separating element 20 is preferably a linear variable filter (LVF), such as the one manufactured by Optical Coating Laboratory, Inc., or it may be any other functionally equivalent component, such as a prism or a grating.

Detector 22 produces waveform signals containing spectral data. The pixels of array 22 spatially sample the continuous band of wavelengths produced by light separating element 20 and produce a set of discrete signal levels. Detector 22 is preferably a photodiode array or other image capture device, such as a complimentary metal oxide semiconductor (CMOS) array, but could be a Charge Coupled Device (CCD) array.

Control circuitry 24 controls operation of produce data collector 12 and produces digitized produce data waveform signals. For this purpose, control circuitry 24 preferably includes an analog-to-digital (A/D) converter. A twelve bit A/D converter with a sampling rate of 22-44 kHz produces acceptable results.

Computer 14 executes produce recognition software 28 which obtains produce data from produce data collector 12, identifies produce item 30 by comparing produce data in produce data file 32 with collected produce data, retrieves an item identification number from produce data file 32 and a corresponding price from price look-up (PLU) file 34 containing price information for barcoded and non-barcoded within a store.

Computer 14 may be a transaction terminal or a transaction server within the store. Likely candidates for identifying produce item 30 may be displayed to an operator for verification.

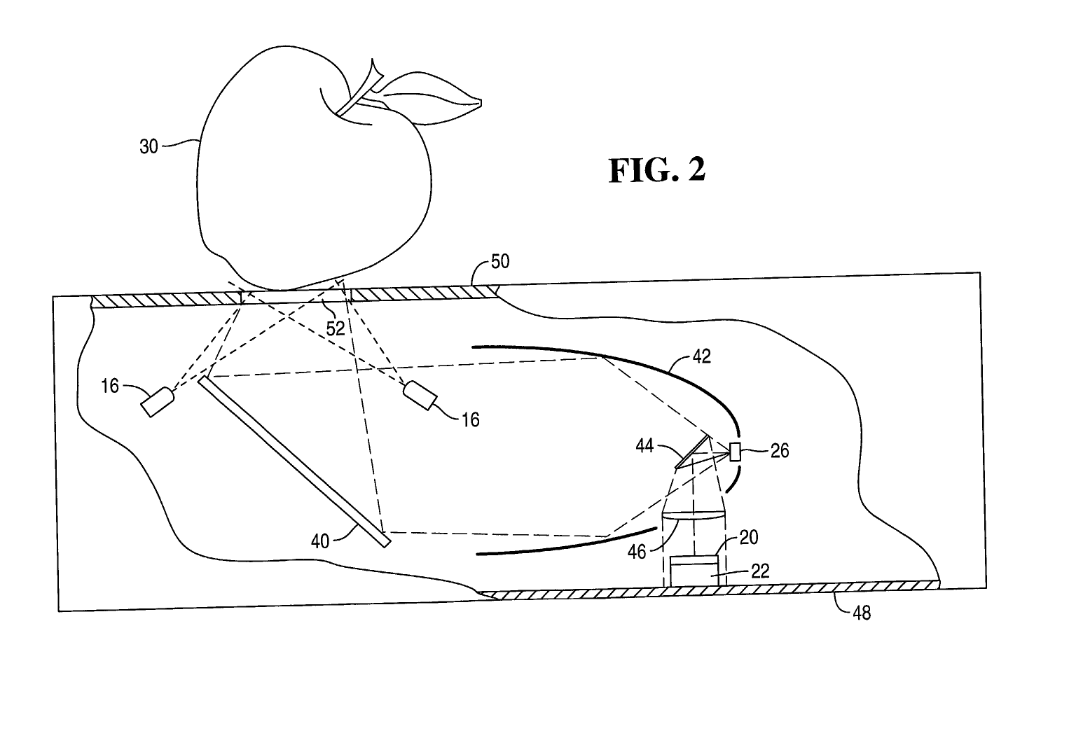

Turning now to FIG. 2, a first embodiment of produce data collector 12 is illustrated in detail. Produce item 30 is shown over aperture 52 in wall 50 of housing 62. Aperture 52 may also be located in a scale weigh plate. Light source 16 illuminates produce item 30 through aperture 52.

In this embodiment, collecting optics 18 additionally includes reflecting mirror 40, compound parabolic collector (CPC) 42, reflecting mirror 44, and collimating lens 46.

Reflecting mirror 40 directs reflected light from produce item 18 towards CPC 42.

CPC 42 directs the collected light on Lambertian reflector 26. A CPC is a high efficiency collector that concentrates light beams of different incident angle near its focal region.

Lambertian reflector 26 is located at the focal region of CPC 42. Lambertian reflector 26 is like a scrambler that erases the trace of contribution of light onto a pixel in detector 22 to a certain region of the produce item. Lambertian reflector 26 scatters the light incident upon it into all directions uniformly. A piece of non-glossy white paper and a white interior wall are two good examples of a reflector that has scattering property similar to that of Lambertian reflector 26. Each point in Lambertian reflector 26 is like a isotropic point light source that radiates uniformly into all directions. Thus, the light incident on a pixel of detector 22 is composed of light from all points in Lambertian reflector 26.

Labsphere, Inc. (North Sutton, N.H.) manufactures a variety of materials and coatings that make Lambertian reflectors close to perfect reflectors. These materials are machinable or capable of use as coatings that can be applied to a variety of substrate material.

Advantageously, use of Lambertian reflector 26 and CPC 42 maximize the amount of available reflected light which reaches detector 22. Thus, produce data collector 12 is very efficient. Also, light source 16 may be one which does not comply with a stringent standard for uniformity of illumination. For an LED light source 16, the number of required LED's for acceptable operation may be reduced significantly without having to decrease the optical distance between aperture 52 and detector 22.

Reflecting mirror 44 directs scattered light from Lambertian reflector 26 towards collimating lens 46.

Collimating lens 46 collects the scattered light from Lambertian reflector 26 and focuses it onto detector 22. The incident angle is limited by the small size of Lambertian reflector 26 and a relatively long focal length of lens 46. Collimating lens 46 limits the angle of light beams incident onto light separating element 20.

Detector 22 is mounted on printed circuit board 48, which includes control circuitry 24.

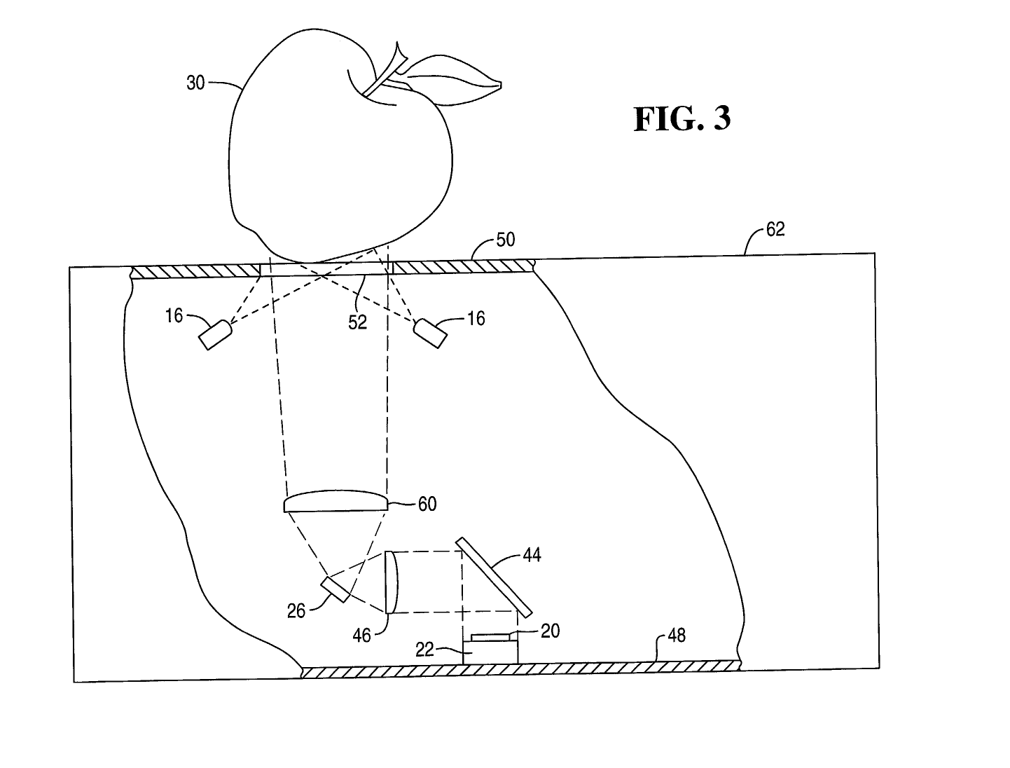

Turning now to FIG. 3, a second embodiment of produce data collector 12 is illustrated in detail. This embodiment is similar to that of FIG. 2, except that lens 60 is used in place of CPC 42.

Lens 60 is less expensive than CPC 42. Given the distance the light must travel to reach detector 22, collection efficiency and compactness may suffer, but less than if Lambertian reflector 26 were not used. Collection efficiency decreases as the distance the light travels increases. Intensity falls off with the square of the distance from the source. Also, collection efficiency may be low due to the small collection aperture (area of a pixel) in detector 22.

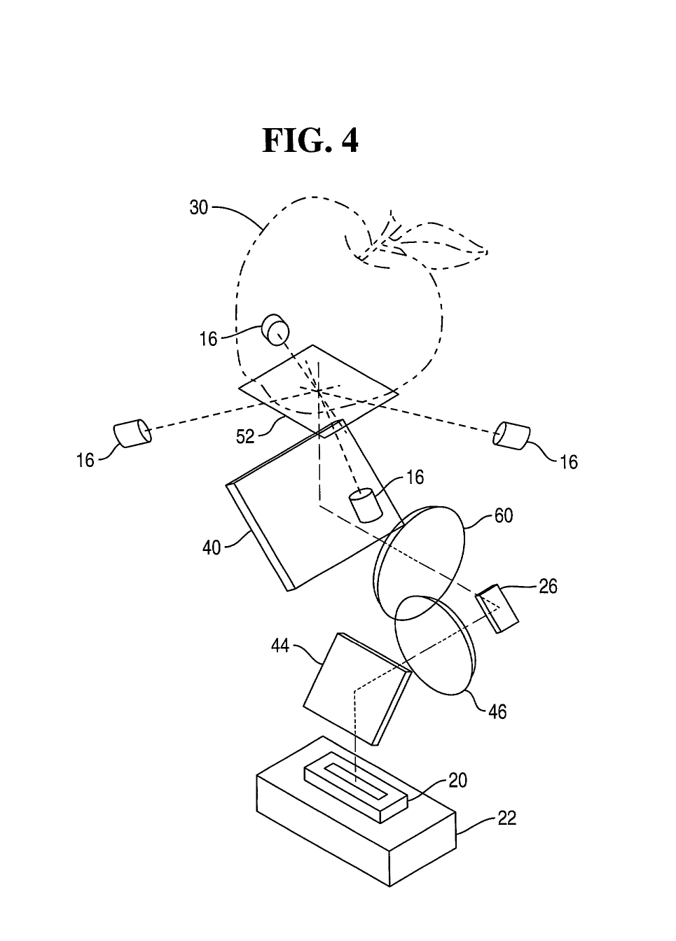

Without CPC 42, more LED's may be required in order to provide enough light to detector 22. Alternatively, the distance light must travel may be shortened in order to increase the amount of light. Under a first modification (FIG. 4), collecting optics 18 is folded, which also has the advantage of reducing the size of housing 62.

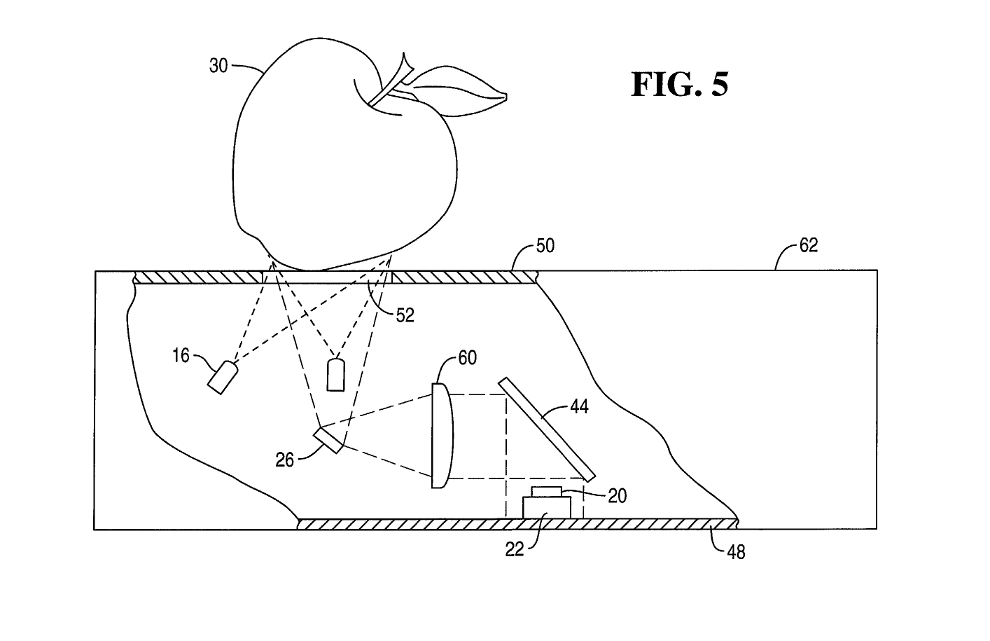

In a second modification (FIG. 5), Lambertian reflector 26 precedes lens 60, allowing the distance between Lambertian reflector 26 and aperture 52 to be reduced. Advantageously, reducing the distance also helps satisfy compact packaging requirements.

Although the invention has been described with particular reference to certain preferred embodiments thereof, variations and modifications of the present invention can be effected within the spirit and scope of the following claims.

We claim:

1. A produce data collector comprising:
a light source for illuminating a produce item with light;
collecting optics for collecting reflected light from the produce item including a Lambertian reflector;
a light separating element which produces an image from collected light; and
an image capture device which captures discrete wavelengths within the collected light.

2. The produce data collector as recited in claim 1, wherein the light source has a white light spectral distribution in a range of wavelengths from about 400 nm to 700 nm.

3. The produce data collector as recited in claim 1, wherein the light source comprises a number of light emitting diodes.

4. The produce data collector as recited in claim 1, wherein the collecting optics further comprise a compound parabolic mirror which directs the collected light onto the Lambertian reflector.

5. The produce data collector as recited in claim 1, wherein the Lambertian reflector is located at a focal region of the compound parabolic mirror.

6. The produce data collector as recited in claim 1, wherein the collecting optics further comprise a collimating lens which collects scattered light from the Lambertian reflector and focuses it onto the image capture device.

7. The produce data collector as recited in claim 1, further comprising a housing, including an aperture through which the light from the light source illuminates the produce item and through which the reflected light from the produce item passes to the collecting optics.

8. The produce data collector as recited in claim 7, wherein the collecting optics further comprise first and second mirrors which fold the collected light in order to minimize housing size.

9. The produce data collector as recited in claim 1, wherein the collecting optics further comprise:
a first mirror which folds the reflected light towards the Lambertian reflector; and
a second mirror which folds scattered light from the Lambertian reflector towards the light separating element.

10. The produce data collector as recited in claim 1, wherein the collecting optics further comprise:
a first mirror which folds the reflected light in a first substantially perpendicular direction;
a compound parabolic mirror which directs the reflected light onto the Lambertian reflector;
a second mirror which folds scattered light from the Lambertian reflector in a second substantially perpendicular direction; and
a collimating lens which collects the scattered light and focuses it onto the light separating element.

11. The produce data collector as recited in claim 1, wherein the collecting optics further comprise:
a focusing lens which directs the reflected light onto the Lambertian reflector.

12. The produce data collector as recited in claim 1, wherein the collecting optics further comprise:
a focusing lens which directs the reflected light onto the Lambertian reflector;
wherein the Lambertian reflector scatters the reflected light in a first substantially perpendicular direction;
a collimating lens which collects scattered light from the Lambertian reflector; and
a second mirror which folds scattered light from the Lambertian reflector in a second substantially perpendicular direction towards the light separating element.

13. The produce data collector as recited in claim 1, wherein the Lambertian reflector scatters the reflected light in a first substantially perpendicular direction and wherein the collecting optics further comprises:
a collimating lens which collects scattered light from the Lambertian reflector; and
a mirror which folds scattered light from the Lambertian reflector in a second substantially perpendicular direction towards the light separating element.

14. The produce data collector as recited in claim 1, wherein the light separating element comprises a linear variable filter.

15. The produce data collector as recited in claim 1, wherein the image capture device comprises a photodiode array.

16. The produce data collector as recited in claim 1, further comprising control circuitry which produces digitized wavelength signals.

17. A produce data collector comprising:
a light source for illuminating a produce item with light;
collecting optics for collecting reflected light from the produce item including
a compound parabolic mirror having a focal region;
a Lambertian reflector substantially located in the focal region which scatters the reflected light; and
a collimating lens which collimates scattered light from the Lambertian reflector;
a light separating element which produces an image from collected light; and
an image capture device which captures discrete wavelengths within the collected light.

18. A produce recognition system comprising:
a produce data collector including
a light source for illuminating a produce item with light;
collecting optics for collecting reflected light from the produce item including a Lambertian reflector;
a light separating element which produces an image from collected light;
an image capture device which captures discrete wavelengths within the collected light; and
control circuitry which produces digitized wavelength signals; and
a computer coupled to the produce data collector which compares the digitized wavelength signals to a library of digitized wavelength signals to identify the produce item.

19. The produce recognition system as recited in claim 18, wherein the computer produces a number of possible candidate identifications for the produce item and corresponding probabilities and displays the candidate identifications for operator verification.

20. A method of collecting produce data from a produce item comprising the steps of:
(a) illuminating the produce item with light;
(b) scattering reflected light from the produce item by a Lambertian reflector;
(c) splitting scattered light from the Lambertian reflector into a plurality of different light portions having different wavelengths;
(d) converting energy in the plurality of light portions into a plurality of electrical signals; and
(e) digitizing the plurality of electrical signals to produce a digital spectrum from the produce item.

21. The method as recited in claim 20, further comprising the step of:
(f) collimating the scattered light before step (c).

22. The method as recited in claim 20, further comprising the step of:
(f) focusing the reflected light on the Lambertian reflector before step (b).

23. The method as recited in claim 20, further comprising the step of:
(f) concentrating the scattered light on the Lambertian reflector by a compound parabolic mirror before step (b).

24. A method of recognizing a produce item comprising the steps of:
(a) illuminating the produce item with light;
(b) scattering reflected light from the produce item by a Lambertian reflector;
(c) splitting scattered light from the Lambertian reflector into a plurality of different light portions having different wavelengths;
(d) converting energy in the plurality of light portions into a plurality of electrical signals;
(e) digitizing the plurality of electrical signals to produce a digital spectrum from the produce item; and
(f) comparing the digital spectrum to reference spectra to identify the produce item.
